(19) United States
(12) Patent Application Publication
(10) Pub. No.: US 2004/0254763 A1
(43) Pub. Date: Dec. 16, 2004

(54) Medical system

(76) Inventors: Shuji Sakai, Fukuoka-shi (JP); Kenichi Niwa, Otawara-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/792,805

(22) Filed: Mar. 5, 2004

(30) Foreign Application Priority Data
Mar. 5, 2003 (JP) 2003-058583

(51) Int. Cl. G06F 15/00; G06F 11/30

(52) U.S. Cl. 702/184; 382/128; 709/219; 700/17

(57) ABSTRACT

A medical system which displays medical images based on the data acquired by a medical diagnostic apparatus and to which the observations on the medical images are inputted, the medical system comprising an operation unit to carry out the operation of changing the display state of medical images, a display image forming unit which performs a pre-determined image process on the basis of an operation on the operation unit and forms a medical image for display, an input unit to which observations on the medical images are inputted, an observation progress information generating unit which generates observation progress information about the medical images, and a storage unit which stores the observation progress information and the observations into a database in such a manner that they are correlated to one another.

### CROSS-REFERENCE TO RELATED APPLICATIONS

This application is based upon and claims the benefit of priority from prior Japanese Patent Application No. 2003-058583, filed Mar. 5, 2003, the entire contents of which are incorporated herein by reference.

### BACKGROUND OF THE INVENTION

1. Field of the Invention

This invention relates to a medical system which displays medical images acquired by a medical image diagnostic apparatus and stores the observations on the medical images.

2. Description of the Related Art

In recent years, medical image diagnostic apparatuses which provide medical images showing the state of the interior portions of the body have been widely used. The medical image diagnostic apparatuses include X-ray diagnostic apparatuses, X-ray CT apparatuses, MRI apparatuses (Magnetic Resonance Imaging apparatuses), ultrasound imaging apparatuses, and nuclear medicine diagnostic apparatuses.

A medical image viewing system is known as one of the apparatuses which display medical images acquired by the medical image diagnostic apparatuses and to which the observations (interpretations) on the medical images are inputted. The medical image viewing system includes a graphical user interface (GUI) for carrying out operations, including various image processes. Using the GUI, the diagnostic reading doctor (observer) displays the medical images subjected to the processes, including a filter process, a contrast adjusting process, an edge emphasizing process, an enlarging/reducing process, a three-dimensional image volume rendering process, an MIP (maximum/minimum value projection) process, and an MPR (multi-plane reconstruction) process. The diagnostic reading doctor observes whether there is any medical abnormality (focus) or the like in the medical image displayed. If there is any abnormality, the doctor inputs the region suspected to be abnormal and comments, including the name of the disease, as the observations. If necessary, the doctor enters as the observations the images processed or marked so that the region suspected to be abnormal may be observed easily. These observations are stored as a diagnostic reading report into a report server. The report server, which stores diagnostic reading reports in the form of a database, is configured to enable search, reading, and others as needed.

Such a medical image viewing system has been disclosed in, for example, Jpn. Pat. Appln. KOKAI Publication No. 2001-22867.

With the recent sophistication of medical image diagnostic apparatuses, it is possible to form medical images from a collection of medial images of many cross sections and from volume data about a three-dimensional region. In addition, as medical image viewing systems are getting more sophisticated, it is possible to subject the medical images to various image processes. Now that many medical images can be observed by various methods, the point is that what method or what procedure should be used in observing medical images.

However, since a conventional medical image viewing system does not store a record of progress in the observation of diagnostic reading reports, this causes a problem: whether the diagnostic reading was made properly cannot be confirmed in the future.

### BRIEF SUMMARY OF THE INVENTION

It is, accordingly, an object of the present invention to provide a medical image viewing system capable of confirming, in the future, the progress of the observation in preparing a diagnostic reading report.

According to the present invention, there is provided a medical system which displays medical images acquired by a medical diagnostic apparatus and to which the observations on the medical images are inputted, the medical system comprising: an operation unit to carry out the operation of changing the display state of medical images; a display image forming unit which performs a pre-determined image process on the basis of an operation on the operation unit and forms an observation medical image; an input unit to which observations on the medical images are inputted; an observation progress information generating unit which generates observation progress information that is about the medical images and that includes at least one of information about the devices constituting a medical image viewing apparatus and information about application software programs installed in the medical image viewing apparatus; and a storage unit which stores the observation progress information and the observations into a database in such a manner that they are related to one another.

### BRIEF DESCRIPTION OF THE SEVERAL VIEWS OF THE DRAWING

FIG. 1 shows the configuration of a medical image viewing system 10;

FIG. 2 shows the configuration of a viewer 26;

FIG. 3 shows the configuration of a report server 25;

FIG. 4 shows an example of observation progress information;

FIG. 5 shows a diagram to help explain an operation sequence of the medial image viewing system;

FIGS. 6A and 6B show examples of the display screen of the viewer 26;

FIG. 7 shows an example of the data stored in a diagnostic reading report database 255;

FIG. 8 is a flowchart to help explain the flow of the operation of the medical image viewing system 10;

FIG. 9 shows an example of the analysis of the observation progress information; and

FIG. 10 shows an example of the analysis of the observation progress information.

### DETAILED DESCRIPTION OF THE INVENTION

Hereinafter, referring to the accompanying drawings, an embodiment of the present invention will be explained. In the explanation below, the component elements having almost the same functions and configurations are indicated by the same reference numerals. A repeated explanation will be given only when necessary.

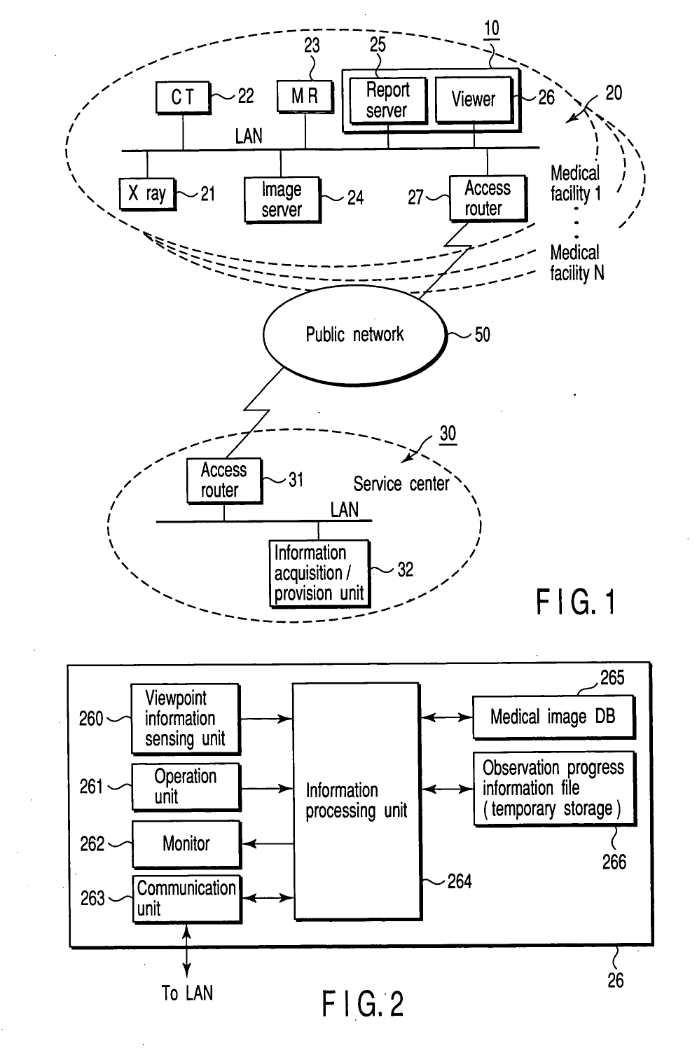

First, the configuration of a medical image viewing system according to the embodiment will be explained by reference to FIG. 1. FIG. 1 is composed of a medical facility system 20, a maintenance company system 30, and a public network 50.

The medical facility system 20 is constructed by using an in-hospital LAN or the like provided in medical facilities, such as hospitals. The medical facility system 20 includes an X-ray diagnostic apparatus 21, an X-ray CT apparatus 22, an MRI apparatus 23, an image server 24, a report server 25, a viewer (medical image viewing apparatus) 26, and an access router 27. In the embodiment, explanation will be given on the assumption that the report server 25 and viewer 26 constitute a medical image viewing system 10. The medical image viewing system is not limited to the embodiment and may be composed of, for example, a single apparatus.

Various medical image diagnostic apparatus, including the X-ray diagnostic apparatus 21, X-ray CT apparatus 22, and MRI apparatus 23, generate medical images showing the state of the internal parts of the subject. The images generated by the individual apparatuses are stored in the image server 24 via the in-hospital LAN.

The image server 24 acquires, via the LAN, the images gathered by the various medical image diagnostic apparatuses and stores them into a magnetic storage unit or onto an optical disk. The image server 24 can store not only medical images from the various medical image diagnostic apparatuses but also examination-related information, order information, and report information.

The report server 25 displays a list of examinations involving diagnostic reading (observation) and makes a diagnostic reading report from the result of the diagnostic reading of medical images. The report server 25 and the viewer 26 are arranged side by side so that the diagnostic reading doctor can operate them at the same time. While viewing the medical images displayed on the viewer 26, the doctor enters the result of the diagnostic reading into the report server 25. The diagnostic reading report includes the presence or absence of an abnormality in the medical images, the name of the region suspected to be abnormal, the comments, including the name of the disease, and the report images formed by the viewer 26. Information about the comments and information about the report images are related to the patient's identification information and stored into the report server 25 in the form of a database. Furthermore, the report server 25 relates observation progress information (explained later) generated at the viewer 26 to the comment information and report images (or identification information to identify the report images) and stores the resulting information in the form of a database. The configuration of the report server 25 will be explained in detail later. The function of the report server 25 may be realized by providing the same function in the viewer 26.

The viewer 26 displays the medical images sent from the image server 24 or the like via the LAN on a display section. The viewer 26 is configured to display a specified medical image according to the operation on the viewer 26 or to the request of the report server 25. The observer, such as the diagnostic reading doctor, can subject the medical images to predetermined image processes (including volume rendering, MIP, MPR, picture quality adjustment, and speed control of frame advance display) on the viewer 26, thereby forming a report image. Furthermore, the viewer 26 can send the report image to the report server 25 by pre-determined operations. The configuration of the viewer 26 will be explained in detail later.

The access router 27 is a device which connects the in-hospital LAN to a public network, such as the Internet, or a dedicated line.

(Configuration of Viewer)

FIG. 2 shows the configuration of the viewer 26. As shown in FIG. 2, the viewer 26 comprises a viewpoint information sensing unit 260 which senses the movement of the viewpoint of the diagnostic reading doctor, an operation unit 261, such as a mouse or a keyboard, a monitor 262 for display, a communication unit 263 for communicating with another apparatus via the LAN, an information processing unit 264 for carrying out various information processes on the basis of control programs, a medical image database 265 for storing the medical images sent from the image server 24 or the like, and an observation progress information file 266 for storing observation progress information temporarily.

The information processing unit 264 displays graphical icons or the like related to the operations of various image processes as a graphical user interface (GUI) on the monitor 262. The information processing unit 264 carries out various information processes according to the icon chosen by the diagnostic reading doctor. The image processes include, for example, the selection of medical images, image processing, the marking of abnormal parts in the medical images, and the transmission of the formed report images to the report server 25. Instead of the GUI, various image processes may be carried out on the basis of the viewpoint sensed by the viewpoint information sensing unit or the speech recognized by a speech recognition unit.

While the diagnostic reading doctor is operating for diagnostic reading, the information processing unit 264 records information about the instruction input operation performed using the GUI, information about the viewpoint sensed by the viewpoint information sensing unit 260, and others sequentially into the observation progress information file 266. The viewpoint information can be stored only under a pre-determined condition by setting a viewpoint information recording condition. For example, as for a condition for storage, setting a condition by function, such as “Image on display,” “Cinema on display,” or “3-D display” can be considered. With such condition setting, the amount of viewpoint information to be store can be reduced. After the diagnostic reading work in the examination has completed, the observation progress information recorded in the observation progress information file 266 is sent to the report server 25. Then, the observation progress information, together with the images interpretation report, is stored into the diagnostic reading report database 255.

Furthermore, the information processing unit 264 can reproduce the observation progress of the diagnostic reading report on the basis of the request of the report server 25 or the instruction through the GUI. When the diagnostic reading report is read or the observation progress is reproduced, the information processing unit 264 reads the observation progress information stored in the diagnostic reading report database 255 and reproduces it. In the reproduction, the various operations are reproduced at the same time intervals at which the operations were performed in the diagnostic reading work. This makes it possible to confirm what images the diagnostic reading doctor viewed at what time intervals. Furthermore, when the production is carried out, whether the displayed medical images have been falsified is confirmed using hash values (explained later). If the medical images might have been falsified, a warning of the alteration is displayed.

The observation progress information file 266 stores such elements as operation history information about the viewer 26, apparatus information, and viewpoint information, additional information in time sequence. Each of the elements has the following contents.

Apparatus information: Information to determine the observation condition in terms of computer hardware and software, including the type of graphic board related to the monitor and graphic board, driver information, information on the version or the like, information about the application software to be used, information on the version of the viewer software or the like, information about the monitor adjustment setting, and information (model number, the capacity of memory mounted, the serial number of the CPU) to identify the computer used as the viewer.

Operation history: A history of operations performed on the viewer 26 via the GUI. For example, the contents of operations are a history of operations, including “Selection of examination,” “Image process,” “Image enlargement/reduction,” “Edge emphasizing process,” “Luminance adjustment,” “Image display,” “Display form change,” “Increase/decrease of the number of display frames,” “Display speed change,” “Report preparation,” “Report saving,” “Image printing,” “Image data transfer,” “MPR process,” “MIP process,” “Volume rendering process,” and “Change of projection direction.” With the GUI, those operations are carried out using icons. In the operation history, the contents of the operation, the user's identification information (log-in name), and the date on which the operation was performed are written. In recording the operation history, the contents of the operation, together with setting information related to the contents of the operation, information to determine the used examination and medical images, and others, are stored so that the observation condition can be reproduced in the future. In determining the name of the user, a method of determining the user's name automatically on the basis of the retina, fingerprints, or other features of the body may be used.

Viewpoint information: For example, the user wears a viewpoint information sensing unit 260, such as an eye scanner, for sensing and tracking the user's eyes. Viewpoint information is obtained by causing information about the user's eyes supplied from the scanner to correspond to positions on the screen. The viewpoint information includes the observation time at the viewpoint. That is, when the movement of the viewpoint stops at a certain position on the image, let the time at which the viewpoint stops in that position be the observation time. At this time, it is desirable to set arbitrarily the time interval in which the eyes are sensed, in order that suitable tracking can be done according to the moving speed of the eyeballs. In this way, the observation time is stored in the form of a history, which enables the user to know how much time was spent for image observation even after a pre-determined time has elapsed since the diagnosis. In addition, when the diagnostic reading procedure is reproduced later, where the viewpoint of the observer was at that time can be visualized. Furthermore, when the diagnostic reading procedure is reproduced later, since the observation time can be found from the records, such adjustment as omitting the observation time can be made.

Additional information: Pre-determined information about the images used in diagnosis and information that makes it possible to determine whether or not the images showing the pre-determined information are correct (the hash values of the images used are used). The hash values are identification information obtained from the medical image data by doing pre-determined calculations. It is possible to determine whether the medical images are identical with each other, depending on whether the hash values are the same. Furthermore, using the hash values as management addresses for data enables the accuracy of the determination of the data to be improved and the reading speed to be made faster. In addition, the hash values can be used in checking the conformity of the report image with the result of the report. Moreover, the hash values can be used in checking the conformity of the data on the viewer 2 side with the data on the report server 25 side.

Furthermore, the additional information may include an evaluation by a report, the feedback of the result of a conference or the like, an evaluation by an adviser or the like, and an evaluation by an examination agency (an agency that acquires data and makes evaluations).

The medical image database 265 stores the images acquired by various examination units in the form of a database. The medical image database 265 includes a database the viewer 26 itself has stored beforehand and a database newly acquired from the image server 24 via the LAN.

The communication unit 263 exchanges medical images and observation progress information with the viewer 26 and an information acquisition/provision unit 32 at a service center via the in-hospital LAN or the public network.

(Report Server)

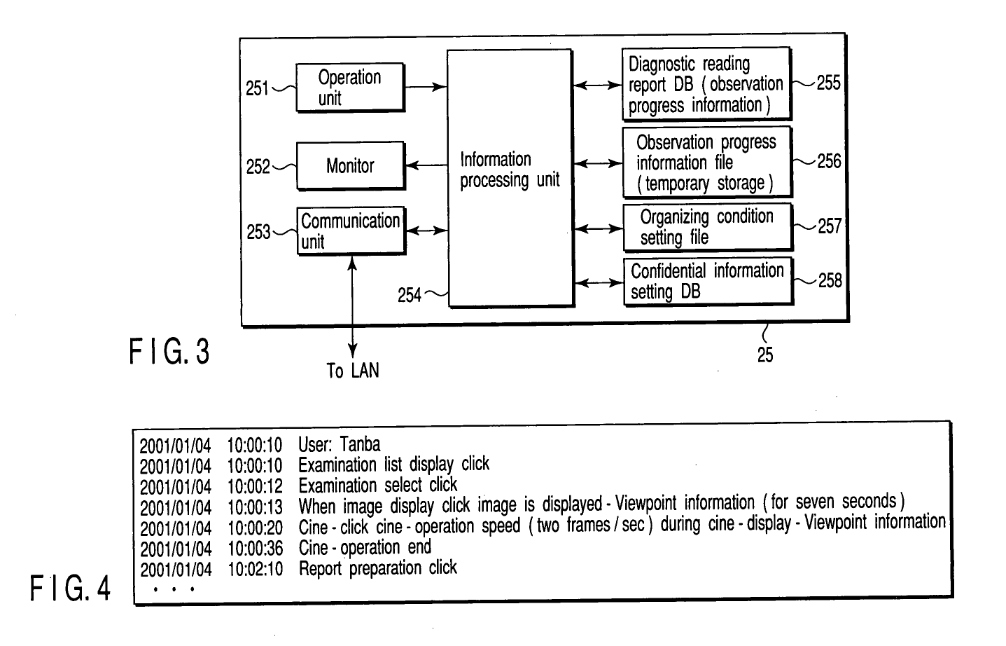

FIG. 3 schematically shows the configuration of the report server 25. As shown in FIG. 3, the report server 25 comprises an operation unit 251, a monitor 252, a communication unit 253, an information processing unit 254, a diagnostic reading report database 255, an observation progress information file 256, an organizing condition setting file 257 used in a statistical analysis process, and a confidential information setting database 258 for storing information on items or the like prevented from being displayed in outputting the result of statistical analysis.

When the user gives a list display instruction from the operation unit 251, the information processing unit 254 searches the diagnostic reading report database 255 and displays a list of examinations involving diagnostic reading on the monitor 252. When the image interpreter selects one from the list, the information processing unit 254 displays a screen for preparing a diagnostic reading report of the examination on the monitor 252 and at the same time, requests the viewer 26 to display the medical images related to the examination.

When the diagnostic reading doctor enters a comment (remark) on the presence or absence of a medical abnormality in the medical image under observation and the contents of the abnormality, the information processing unit 254 writes the comment into the diagnostic reading report. There may be a case where the diagnostic reading doctor does not enter the comment and operate the apparatus and another operator (transcriber) carries out the entry and operation according to the doctor's instructions. In this case, individual identification information to identify a person who entered the data is recorded into the operation history, which makes it possible to confirm later whether the person who entered the data was the diagnostic reading doctor or the transcriber. As for the input of the comment, what is told may be converted into text information with a speech recognition unit. In this case, the result of the input from the unit is recorded in the form of an operation history. Furthermore, the doctor's voice information itself may be recorded with a voice recorder. In this case, the information processing unit 254 has a function that enables to check whether the doctor's voice information corresponds to the text information or the like or not.

The information processing unit 256 stores an operation history using graphical icons or the like with the report server 25 and an operation history or the like related to the input of the comments into the observation progress file 256 in such a manner that the elapsed time of the operation can be grasped. In the observation progress information file 256, such an element as apparatus information is also stored.

Receiving the report image from the viewer 26, the information processing unit 254 attaches the report image (or identification information to identify the report image) to the diagnostic reading report. After the diagnostic reading for the examination is completed, the report server 25 stores into the diagnostic reading report database 255 the prepared diagnostic reading report and the observation progress information stored in the observation progress information file 266 of the viewer 26 and in the observation progress information file 256 of the report server 255.

The organizing condition setting file 257 stores index values representing the progress of observation, analysis conditions for obtaining the result of statistical analysis, and others from the observation progress information. The organizing conditions include, for example, “The number of cases by preparation time or period,” “The diagnostic reading time by observer,” “The number of diagnostic readings by observer,” “The number of used image processes by type,” “Evaluation by report,” “Feedback of the result of a conference or the like,” “Evaluation by an adviser,” and “Evaluation by an examination agency (an agency that acquires data and makes evaluations). On the basis of the conditions in the organizing condition setting file 257, the information processing unit 254 can organize pieces of information useful for the user and display them on the monitor 252. The organizing conditions may be acquired from the information acquisition/provision unit 32 via the network.

The confidential information setting database 258 stores a conversion correspondence list of pieces of information to be made confidential (e.g., classified in-hospital information) from the observation progress information. That is, the observation progress information includes confidential information, such as personal data or the like, including the names of the patients and doctors, prohibited from being leaked from the hospital. To make it impossible for the outsider to acquire the classified information, a pre-determined part is converted into a pre-determined form in such a manner that, for example, “Doctor A ? D1012065” and “Doctor B ? D1020654.” Then, the result is stored into the diagnostic reading report database 255. The confidential information setting database 258 stores a correspondence list that causes the information before conversion to correspond to the information after conversion. This enables only the observation progress information that the names of the doctors have been converted into D1012065 and D1020654 to be stored in the diagnostic reading report database 255 as the observation progress information accessible from the outside, thereby preventing the information from being leaked.

FIG. 4 shows an example of the observation progress information stored in the observation progress information files 256, 266. In this example, button clicking operations, including “Log-in user name,” “Examination list display,” “Selection of examinations,” “Image display,” “An increase in the number of frames displayed,” “Display speed,” “Report preparation,” and “Report saving” are written together with the types of instructions caused to correspond to the buttons, the types of operations (clicking, dragging, and the like), and the dates when operations were performed, in the information representing the situation of observation generated by the information processing unit 264. Viewpoint information including the observation time is particularly added to “Image display.”

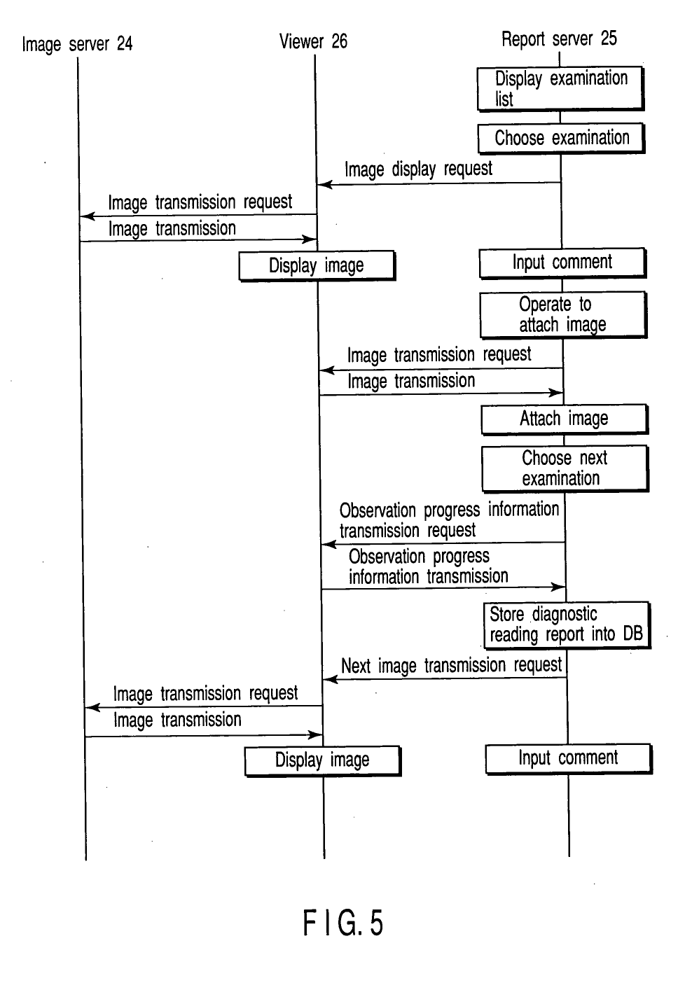

(Explanation of Diagnostic Reading in FIG. 5)

Next, the flow of the entire medical image observation with the medical image viewing system 10 will be explained by reference to FIGS. 5 to 7.

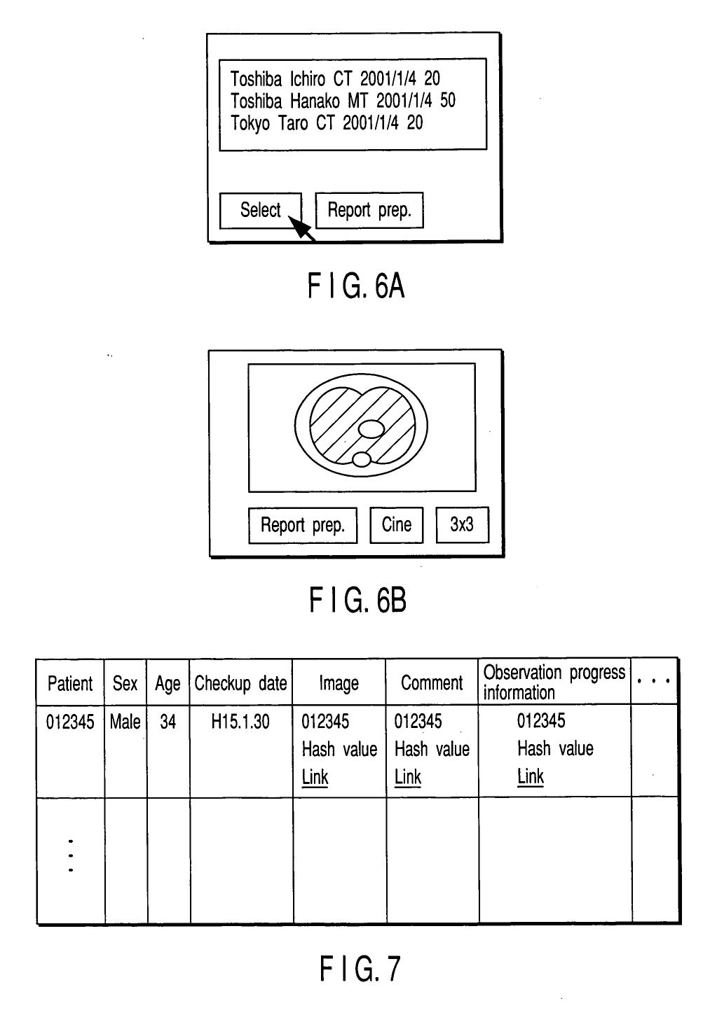

FIG. 5 is a diagram to help explain the sequence of medical image observation. FIGS. 6A and 6B show examples of the display screen of the viewer 26. As shown in FIG. 5, after logging on to the report server 25, when the diagnostic reading doctor gives an instruction to display an examination list, a list of examinations requiring diagnostic reading is displayed on the report server 25 as shown in FIG. 6A. When the diagnostic reading doctor chooses one examination from the list, the viewer 26 is requested to display the medical image corresponding to the examination. The viewer 26 requests the image server 24 to transmit the medical image. Receiving the request, the image server 24 transmits the specified medical image to the viewer 26. The viewer 26 displays the received medical image as shown in FIG. 6B. In the example, 20 CT images are received as medical images. The first one of the images is displayed in a pre-determined size (e.g., 512×512 pixels). When the diagnostic reading doctor presses the cine-display button as needed, for example, to view all the images, the individual images are displayed one after another at a pre-determined speed (e.g., two images/second). The diagnostic reading doctor operates the viewer 26 to carry out image processes, thereby obtaining medical imaged suitable for diagnostic reading.

Next, the diagnostic reading doctor chooses the report preparation button, causes the report server 25 to display a report preparation screen, and enters the remarks about the medical images displayed on the viewer 26. At this time, when the diagnostic reading doctor gives an instruction to attach a report image on the report server 25, the report server 25 requests the viewer 26 to transmit a report image. In response to the request, the viewer 26 transmits the currently displayed medical image as a report image to the report server 25. The report server 25 attaches the received report image to the diagnostic reading report.

When the diagnostic reading doctor gives an instruction to make the next examination on the report server 25, the report server 25 requests the viewer 26 to transmit the observation progress information. Receiving the request, the viewer 26 transmits the contents of the observation progress information file 266 to the report server 25. The report server 25 stores the observation progress information and the diagnostic reading report into the diagnostic reading report database 255. Thereafter, the report server 25 makes a request to display the medial image related to the next examination and repeats the above-described operation.

FIG. 7 shows the data structure stored in the diagnostic reading report database 255. In the diagnostic reading report database 255, the patient's identification information, sex, age, checkup date, report image information, comment information, and observation progress information are stored in such a manner that they are correlated to one another. Identification information to determine the storage locations of the individual actual data items and the hash values obtained from the actual data items are stored as the report image information, comment information, and observation progress information. Use of the hash values makes it possible to confirm whether the data is identical with the stored one, when the data is read in the future.

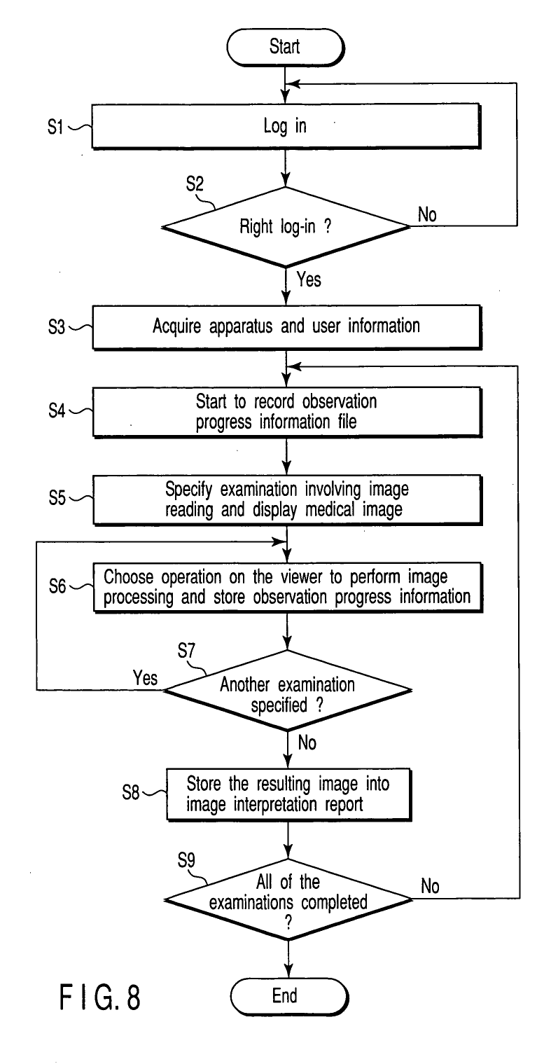

(Explanation of Diagnostic Reading in FIG. 8)

Next, a diagnostic reading operation in the medical image viewing system 10 configured as described above will be explained by reference to FIG. 8.

As shown in FIG. 8, when the user's identification information and password are inputted using the GUI, thereby performing a log-in operation (step S1), it is determined whether the user has logged in properly (step S2). If the user has logged in properly, the user information and others are acquired on the basis of the apparatus information and log-in name and then stored into the observation progress information files 256, 266 (step S3).

Next, when pre-determined examination information or the like is specified, the storage of observation progress information about the examination, that is, the recording of the observation progress information file 266, is started (step S4). Then, the examination involving diagnostic reading is specified. The medical image for the specified examination is displayed (step S5). The user chooses operations on the viewer in connection with the displayed medical images, thereby subjecting the images to the desired image processes. At the same time, the observation progress information is generated and stored in the observation progress information files 256, 266 sequentially (step S6). After the operations on the medical images have been completed, the information processing unit 264 determines whether another examination has been chosen (or specified) (step S7). If another examination screen has not been chosen (or specified), control returns to step S6. If another examination screen has been chosen, the observation progress information stored in the observation progress information files 256, 266 are related to the medical images (report images). The resulting images are stored in the diagnostic reading report database 255 (step S8). Next, it is determined whether diagnostic reading for all of the other examinations has been completed. If all of the examinations have been completed, the process is ended. If any of the examinations is still left, control returns to step S4 (step S8).

(Reproduction of Observation Situation)

The report server 25 and viewer 26 or maintenance information acquisition/provision unit 32 can reproduce the observation situation including the reproduction of the report image on the basis of the acquired observation progress information. The situation may be reproduced by the diagnostic reading doctor's manual operation on the basis of the observation progress information. Alternatively, the situation may be reproduced automatically by each apparatus on the basis of the observation progress information.

(Analysis of Observation Progress Information by a Terminal at the Service Center)

Next, a case where the information acquisition/provision unit 32 at the service center analyses the observation progress information will be explained. The information acquisition/provision unit 32 has the function of analyzing the observation progress information acquired from each report server 25 or viewer 26 on the basis of the organizing condition and transmitting the result of the analysis to each report server 25 or each viewer 26. The analyzing process is the same as that in the report server 25, so its explanation will be omitted.

The information acquisition/provision unit 32 analyzes the observation progress information acquired from the report server 25 and transmits to the report server 25 or viewer 26 the information the user may want, such as the average of the times needed for the users to interpret images or information about the user whose image reading time is short.

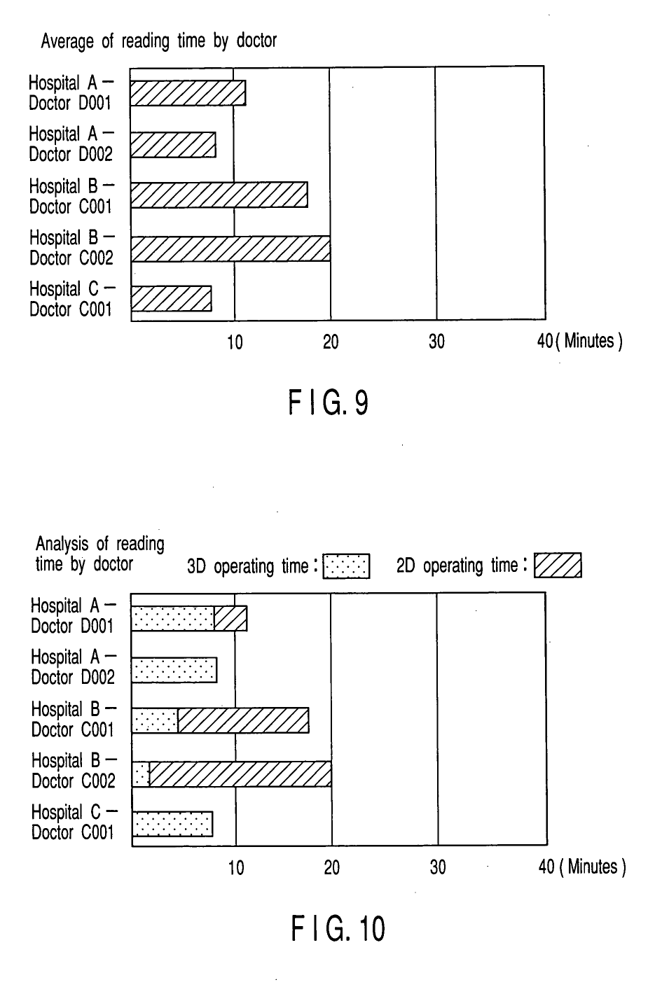

FIGS. 9 and 10 are graphs showing the results of analyzing the diagnostic reading time for each doctor. FIG. 10 particularly shows the ratio of use of three-dimensional images and use of two-dimensional images in the diagnostic reading time of FIG. 9. From the comparison between FIG. 9 and FIG. 10, it is expected that use of three-dimensional images is effective in shortening the diagnostic reading time. Giving the result of the analysis to the report server 25 or viewer 26 enables the diagnostic reading doctor to do work more efficiently by using the report server 25 and viewer 26.

With the above-described configuration, the following effects can be produced.

The report server 25 and viewer 26 or the information acquisition/provision unit 32 at the service center store the observation progress information related to the report image formation in such a manner that the observation progress information is related to the report images and reports. Therefore, the observation situation can be confirmed by outputting the observation progress information as needed. For example, even after several years have elapsed, the observation situation at that time can be confirmed.

Furthermore, the situation at the time of the observation can be reproduced as needed. As in three-dimensional images where the method at the time of diagnostic reading is important, it is possible to confirm in the future whether the diagnostic reading was made properly.

In addition, the observation progress information includes viewpoint information and observing time. This makes it possible to understand what part of the image the diagnostic reading doctor at that time was interested in and how much time the doctor took to diagnose the questionable region.

Moreover, including apparatus information in the observation progress information makes it possible to confirm the observation situation including the difference between displayed states due to the difference between apparatuses.

The report server 25 and viewer 26 can set the organizing condition and analyze the observation progress information under pre-determined conditions. This makes it possible to analyze easily the difference in diagnostic reading method between observers or the observation method of a diagnostic reading doctor whose result of diagnostic reading is excellent.

On the basis of the conversion correspondence list in the confidential information setting database 256, the report server 25 and viewer 26 can convert the confidential information into another information and store the resulting information into the diagnostic reading report database 267. This prevents the confidential information from being leaked to the user who tries to access the database from the outside.

The report server 25 and viewer 26 store the observation progress information and report images in such a manner that they are caused to correspond to the hash values. Therefore, it is difficult to falsify the data, which enables the observation progress information to be stored and reproduced with high security. This makes it possible to provide highly reliable evidence in case of, for example, a medical-error suit.

While in the embodiment, the medical image viewing system has been explained, the present invention is not limited to this. For instance, the invention may be applied to a medical system which includes an X-ray diagnostic apparatus, an X-ray CT apparatus, an MRI apparatus, or the like. In this case, the image displaying section of the X-ray diagnostic apparatus, X-ray CT apparatus, or MRI apparatus is provided with the same function as that of the aforementioned medical image viewing system.

Additional advantages and modifications will readily occur to those skilled in the art. Therefore, the invention in its broader aspects is not limited to the pre-determined details, representative devices, and illustrated examples shown and described herein. Accordingly, various modifications may be made without departing from the spirit or scope of the general inventive concept as defined by the appended claims and their equivalents.

What is claimed is:

1. A medical system which displays medical images acquired by a medical diagnostic apparatus and to which the observations on the medical images are inputted, the medical system comprising:
an operation unit to carry out the operation of changing the display state of medical images;
a display image forming unit which performs a pre-determined image process on the basis of an operation on the operation unit and forms an observation medical image;
an input unit to which observations on the medical images are inputted;
an observation progress information generating unit which generates observation progress information that is about the medical images and that includes at least one of information about the devices constituting a medical image viewing apparatus and information about application software programs installed in the medical image viewing apparatus; and
a storage unit which stores the observation progress information and the observations into a database in such a manner that they are related to one another.

2. The medical system according to claim 1, wherein the observations include at least one of the presence or absence of a medical abnormality in the medical images, a comment on the medical abnormality, and the medical images subjected to the image process.

3. The medical system according to claim 1, wherein the observation progress information includes at least one of information to identify a viewer, information about the date and time of an operation, information about the types of image processes, and information to find the elapsed time of the observation in progress.

4. The medical system according to claim 3, wherein the medical images are three-dimensional images, and
the types of image processes include a volume rendering process in displaying three-dimensional images, an MIP process, an MPR process, an enlargement/reduction process, a projection direction changing process, and a position changing process.

5. The medical system according to claim 1, further comprising:
a viewpoint information acquisition unit which acquires viewpoint information about the viewpoint of the operator on the screen of the display unit, wherein
the observation progress information includes the viewpoint information.

6. The medical system according to claim 1, further comprising:
a reproduction unit which reproduces the observation medical image displayed for observation on the basis of the observation progress information read from the database.

7. The medical system according to claim 1, further comprising:
an analysis unit which analyzes a plurality of pieces of the observation progress information stored in the database.

8. The medical system according to claim 7, wherein the analysis unit compares the observations inputted at the time of observation with the result of the diagnosis inputted after the observation and analyzes the result of the comparison using a statistical process.

9. The medical system according to claim 1, further comprising:
a computing unit which finds hash values on the basis of the observation progress information, wherein
the storage unit stores the hash values and the observation progress information into the database in such a manner that they are correlated to one another.
